(19) United States
(12) Patent Application Publication
(10) Pub. No.: US 2015/0201792 A1
(43) Pub. Date: Jul. 23, 2015

(54) CAPSULE WITH IMPROVED SEALING ELEMENT

(71) Applicant: TUTTOESPRESSO S.r.l., Milano (IT)

(72) Inventor: Luca Doglioni Majer, Carate Urio (IT)

(73) Assignee: TUTTOESPRESSO S.r.l., Milano (IT)

(21) Appl. No.: 14/414,269

(22) PCT Filed: Jul. 1, 2013
(86) PCT No.: PCT/EP2013/063858

§ 371 Date: Jan. 12, 2015

(30) Foreign Application Priority Data
Jul. 16, 2012 (EP) 12005215.4

(51) Int. Cl. A47J 31/40; B65D 85/804; B65D 17/00

(52) U.S. Cl. CPC A47J 31/407; B65D 17/24; B65D 85/8046; B65D 2517/002

(57) ABSTRACT

A capsule for preparing a beverage in a brewing device, including a hollow body including an inlet wall, a lateral wall, and a flange rim including an upper side and a lower side and a sealing element located on the upper side of the flange rim. A lower side of the flange rim includes at least two portions that lie on two or more planes that are at different levels with respect to the capsule axis and provide a space on the lower side of the flange rim.

### TECHNICAL FIELD

The present invention relates to a capsule with a improved sealing element. More particularly, the invention relates to a single use, i.e. a disposable, capsule, or cartridge, for preparing beverage, such as coffee, from a dose of one or more products contained by the capsule, and to a beverage production system comprising a beverage production device (brewing device) for interacting with the capsule.

### BACKGROUND OF THE INVENTION

Beverage capsules, especially disposable capsule for preparing coffee, have been known from the 1930's. Beverage capsules comprise a container portion that houses a dose of at least one extractable or reconstitutable product, generally ground coffee, but also tea herbal extracts, instant i.e. powdered drinks and liquid concentrates. The capsules also comprise a portion that interacts with a brewing device to prepare the required beverage. The typical brewing device comprises water heating means, an enclosing member, or receptacle, intended to cooperate with the capsule to define a preparation chamber and a pump or similar means so that the brewing liquid, preferably hot water under pressure, can be supplied to the capsule for the extraction or reconstitution of the beverage from the dose of product contained therein.

In general, the brewing device includes a first part with a receptacle for housing at least part of the capsule and a second part that cooperates with the first part in the brewing of the beverage from the capsule, the first and/or second part are mobile to each other and the receptacle has one edge, usually positioned in the lower or upper terminal part of the second part, that enters into contact with the sealing element of the capsule to compress it against the second part of the brewing device for providing a seal tight engagement with the capsule during the beverage preparation process.

In a known beverage preparation process a capsule is fed into the receptacle of the brewing device and is injected with the brewing liquid, typically hot water. The injected hot water passes trough it and extracts the beverage from the ingredient enclosed therein. The beverage exits the capsule to reach a beverage collector and thence a cup or a container.

The receptacle encloses at least part of the capsule and cooperates with it in a seal tight engagement in order to allow the hot water to be inserted into the capsule to extract the beverage with no or with limited leakage. Leakage of the brewing liquid may negatively affect the extraction process of the beverage, thus the desired taste and quality of the beverage is not reached.

A known type of capsule has a substantially frusto-conical body and a rim flange portion extending from one of the two bases of the capsule. The brewing device comprises means to compress the receptacle against the flange so as to reach the required sealing during the brewing step. There are known capsules provided with a flange that is located in correspondence of the side of the capsule where the beverage outlet is located. The beverage leaves the capsule from the base where the flange is located. A sealing between the flange and the receptacle is requested to avoid water leaking from the receptacle.

In known brewing devices the seal tight engagement between the capsule and the receptacle is generally obtained by exerting a pressure on the rim flange; in other words, the receptacle which is cup-shaped in order to enclose the capsule, is pressed against the flange-like rim of the capsule, i.e. a rim extending from the lateral surface of the capsule, along its perimeter and against a receiving plate where means for piercing the capsule are located.

The problem exists of ensuring a seal tight engagement between the capsule and the receptacle of the brewing device. In fact, a leak of the brewing liquid outside the capsule can reduce the pressure inside the capsule and therefore reduce the extraction of the coffee flavours; in addition, water discharged to the drip-tray of the dispensing machine or even fed to the cup will be unpleasant to see. Should water reach the cup because of an inferior sealing quality and thus dilute the taste of the beverage extracted from the capsule, organoleptic characteristics and quality of the produced beverage will be affected.

Known capsules provided with a resilient material, acting as a sealing member, are not suitable to solve the above problem and other solutions have been proposed to ensure a satisfactory seal tight engagement between the capsule and a receptacle provided with irregularities. The sealing portion should ensure that the pressing portion of the receptacle does not remain stuck into the sealing portion of the capsule at the end of the brewing step, when the used capsule has to be removed from the receptacle (as it is often the case with rubber-like sealing elements).

Additionally, there is the problem of having a capsule that can be used with different types of known brewing machines: often one type of capsule cannot work, or works with difficulty, with different models of brewing machines. This is because in different types of machines, due to imprecise engineering or careful evaluation of the side effects of deliberate engineering choices, the length of the movement of the first and second parts is not exactly identical and therefore the sealing element may result to be too big in one machine (causing difficulty in closing the machine) or too small for the machine (causing a leakage of water). Also, in one same machine, repeated use may result in wear and tear causing slight changes of the travel distance of the first and second portions of the machine and possible leakages of water from the brewing chamber with time.

EP1654966 discloses capsules provided with a resilient material, acting as a gasket or sealing member, which is added in correspondence of the flange-like rim, in order to engage the pressing portion of the receptacle and to interact with the receptacle to provide the desired seal tight engagement.

WO 2009/115474 discloses a brewing device where the pressing portion of the receptacle, i.e. the edge of the receptacle which is brought into contact with the capsule, is provided with irregularities, indentations, and/or gaps. According to the description of WO'474, the gaps are obtained in the edge of the receptacle in order to provide it with a flow directing means to control leakage if the device is operated without inserting a capsule. Nevertheless using this device with certain capsules compatible with such receptacle, results in water leaks from the receptacle into the cup where coffee is being collected, providing a negative effect both visually and as far as taste is concerned, not to mention the possible drawback of rapidly filling with excess water the drip tray container.

Capsules are already known having one or more projecting elements, made of the same material of the capsule, and extending from its external surface, and in particular form its flange-like rim, in order to provide the sealing engagement with the receptacle.

WO2010/084475, in the name of Ethical Coffee Company, describes several embodiments of a capsule having projecting elements on its external surface, and in particular on the upper surface of the flange-like rim.

WO2010/137946, to Sara Lee, discloses a capsule having at least one projection for providing a sealing engagement with the receptacle. The proposed projecting elements disclosed in WO2010/084475 and WO2010/137946 are not suitable to solve the above mentioned problem of ensuring a satisfactory seal tight engagement between the capsule and a receptacle of different types of brewing machines. In fact, projecting portions of known capsules cause difficulty in closing the machine and/or leakage of water, depending on the machine where the capsule is used.

It is an aim of the present invention to solve the above problems and to provide a capsule that can be used with different shapes and profiles of the pressing portion of the receptacle, and with different closing mechanisms without affecting negatively the operation of the dispensing unit i.e. creating no problem while closing the machine or inserting/extracting the capsule into/from the receptacle.

Another aim of the present invention is to provide a capsule which is easy to produce and wherein the sealing element is made integral with the capsule body, without the need of adding resilient sealing material on its external surface for providing sealing compensation for the irregularities provided on the receptacle due to wear and tear, imprecise engineering or altogether different closing mechanisms.

### SUMMARY OF THE INVENTION

These and other aims are achieved by means of the capsule of the present invention, that is a disposable capsule for the preparation of a beverage from a dose of a product, according to claim 1. The capsule is insertable into a beverage production device (also called a dispensing unit, or brewing device) comprising a receptacle for enclosing at least part of the capsule. The capsule is provided with a lateral wall, an upper wall and a lower wall forming a hollow body where said product is contained. The capsule further comprises a flange-like rim having an upper side and a lower side, the flange laterally extending from the capsule, and at least one sealing element in the form of a protrusion or projection from the flange-like rim, or in the form of an increased thickness of the flange rim, for providing a seal tight engagement with the pressing portion of the receptacle of the beverage production device when in use, i.e. when the receptacle is pressed against the flange rim of the capsule, e.g. during the brewing step. Thus, the protruding portion is extending from the flange-like rim towards the receptacle. The capsule also comprises a lid that forms the outlet wall of the capsule and that is in part attached to the flange rim of the capsule body.

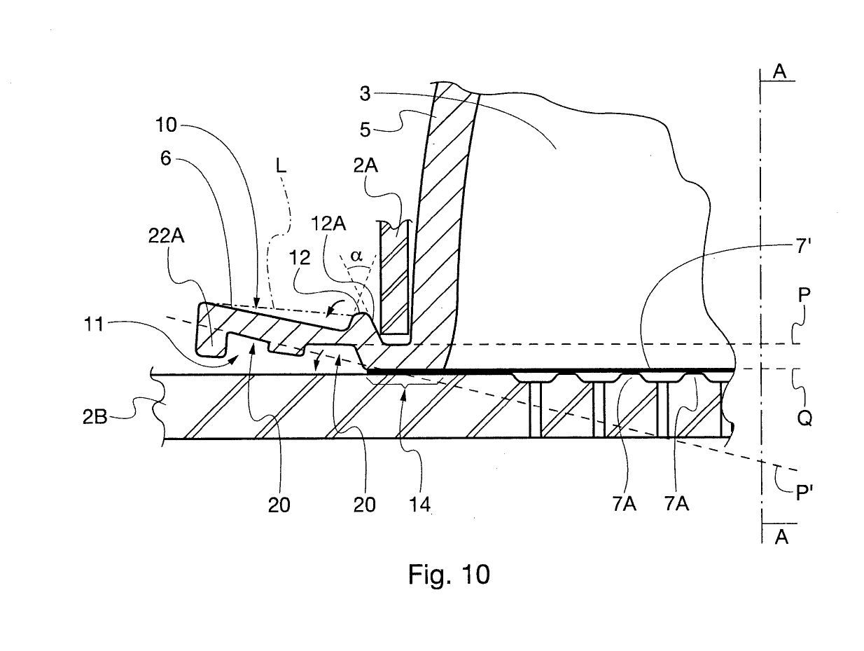

According to the invention, the capsule comprises a hollow body including an inlet wall, a lateral wall and a flange rim, the rim has an upper side and a lower side and a sealing element is located on the upper side of the flange rim, the lower side of the flange comprises at least two portions that are at different levels with respect to the capsule axis (A-A) to provide a cavity on said lower side of the flange rim. In other words, the capsule comprises a hollow body including an inlet wall, a lateral wall and a flange rim, the rim has an upper side and a lower side and a sealing element is located on the upper side of the flange rim, the lower side of the flange comprises at least two portions that lie on two or more planes that are at different levels with respect to the capsule axis (A-A), i.e. the planes meet the said axis of the capsule at different levels. In greater detail, one of the planes, preferably including at least part of the sealing element area, is higher than the other plane, so as to provide a space to receive a portion of the flange rim when the sealing element is compressed during the brewing step by the brewing device. The planes may be parallel to each other or may be not parallel, i.e. they cross, as shown in FIG. 10, here below discussed. More than one plane may be present and the cavity defined on the lower side of the flange may have a non-planar and/or irregular shape.

With “higher” it is meant that with respect to the capsule axis (A-A), one of the planes is closer to the inlet wall (the top wall in the figures) than the other plane(s) of the lower side of the flange rim. In general, in the following description and claims the words “lower” and “upper” or “higher”, “downwards” and “upwards” are referred to the position of parts of the capsule with respect to the capsule axis A-A and the attached drawings, assuming that the inlet wall is located at the highest position of the capsule.

The space (i.e. a kind of cavity) under the flange rim preferably is located at least in part under at least part of the sealing element and preferably also in a portion adjacent to the sealing element; alternatively, the space or cavity is located only adjacent to the sealing element, on the opposite side of the flange rim, i.e. on the lower side of the flange.

The capsule is generally also comprising a lid to close the capsule body, said lid is extending along the flange rim to provide at least one layer of lid material under at least part of the flange rim. In an exemplary embodiment, the flange rim of the capsule body is vertically spaced from the layer formed by the lid at least in the area where the sealing element is located, so as to provide a space to receive a portion of the flange rim when the sealing element is compressed in the brewing device.

The lid is typically selected from a plastic lid and a foil element, but could be made of other materials; a typical foil element is comprising aluminium layer(s) coupled with plastic layers, or appropriate plastic or bio-plastic layers, either thermo-formed or thermo-injected, to provide sealing qualities, flexibility and gas barrier properties, including—at times—oxygen barrier properties.

In particular in the case of a plastic lid, flange and lid wall are usually welded together at a location that is between the edge of the flange rim and the sealing element. When the lid is made of a foil member, the foil can also be welded to a portion of the lower side of the capsule that is between the sealing element and the bottom part of the lateral wall of the capsule (included). In another embodiment, the foil is welded to the portion of the plane that is higher (i.e. closer to the inlet wall); in this case the difference in height, i.e. the distance between the two planes of the lower side of the flange rim, is still sufficient to allow a downwards movement of the corresponding portion of the flange when it is compressed by the brewing device.

A further object of the invention is a system for preparing a beverage characterized according to claim 16. This system comprises a capsule according to the invention and a brewing device including a first part with a receptacle for housing at least part of the capsule and a second part that cooperates with the first part in the brewing of the beverage from said capsule; the first and/or second part are mobile, at least with respect to each other and the receptacle of the first part has a lower edge that enters into contact with the sealing element to compress it against the second part for providing a seal tight engagement with the capsule during the process of preparing a beverage from the ingredients in the capsule.

According to an exemplary embodiment of the invention, the space between the flange rim and the lid is extending from at least part of the sealing element to the wall of the capsule body; in another embodiment of the invention, this space is connected to the inside of the capsule, e.g. by grooves.

In a preferred embodiment the sealing element has a cross-section that is in the shape of a triangle or of a truncated triangle, where the sides of said triangle are extending from the flange rim, directly or through the lateral wall of the capsule, i.e. the triangle is protruding from the flange in a substantially vertical way.

In other words, in this embodiment the sealing element comprises a portion having a substantially triangular cross-section with two sides lying on two straight lines that extend from said upper surface of the flange rim and preferably define an angle (α) within the range 35°-120.

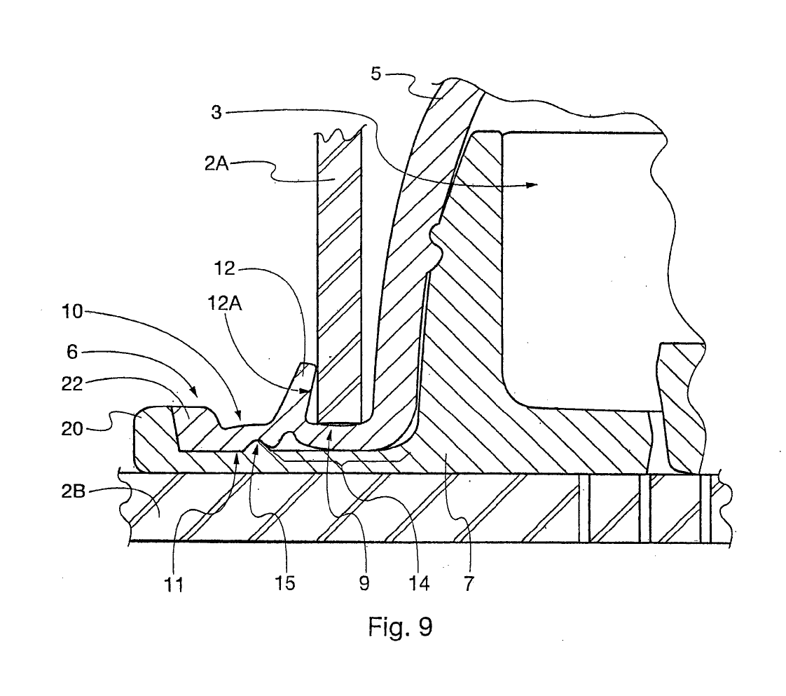

The distance of the sealing element from the lateral wall might be enough to allow the pressing element of the receptacle of the brewing device to be housed in the space between said lateral wall and said sealing element, as shown in FIGS. 9 and 10.

A further object of the invention is a lid for a capsule for preparing beverages, said capsule comprising a hollow body including an inlet wall, a lateral wall and a flange rim, said lid comprising a central portion that closes the hollow body of the capsule and a peripheral portion that cooperates with the flange rim of the capsule body, characterized in that said lid comprises outlet means in the form of a plurality of self-perforating elements that are projecting outwardly from said lid and that are defined by grooves and in that said grooves form a pattern that includes a plurality of acute angles.

The self-perforating elements are breakable under the action of the mechanical force exerted by at least one part of the brewing device and/or by the force exerted by the water fed into the capsule.

In a preferred embodiment, the peripheral portion of the lid has an edge that extends vertically along the edge of the capsule flange rim to provide a more rigid assembly of lid and flange rim. In another embodiment, wherein the lid is made of a foil sealed to the flange rim of the capsule, the flange itself has a reinforcing ridge at its edge; the ridge can extend upwards (from the upper side of the flange towards the inlet wall) or downwards (from the lower side of the flange, away from the inlet wall of the capsule).

Another object of the invention is a process, as per claim 18, of preparing a beverage from a capsule as above disclosed in the previously discussed brewing device, wherein said capsule comprising a hollow body including an inlet wall, a lateral wall and a flange rim, said flange rim having an upper side and a lower side and a sealing element located on the upper side of said flange rim, said brewing device comprising a first part and a second part mobile with respect to each other, wherein the sealing element is compressed and is moved by said first part towards the second part of the device together with a portion of the flange rim of the capsule.

The invention provides several advantages with respect to the prior art.

In fact, the space under the flange rim, namely the space under the sealing element or adjacent to it, provides a “spring” effect that results in an improved sealing of the capsule, that can therefore be used in different types or models of machines where the length of the movement of the first and second part—and therefore the distance between first and second part in a closed condition—is not, by design or coincidence, exactly identical. Also, the spring effect can compensate for the changes in length of the movement of the mobile parts of the brewing machine that could occur as an effect of wear and tear.

The invention will be further disclosed with reference to the enclosed drawings that refer to exemplary and non-limiting embodiments, wherein:

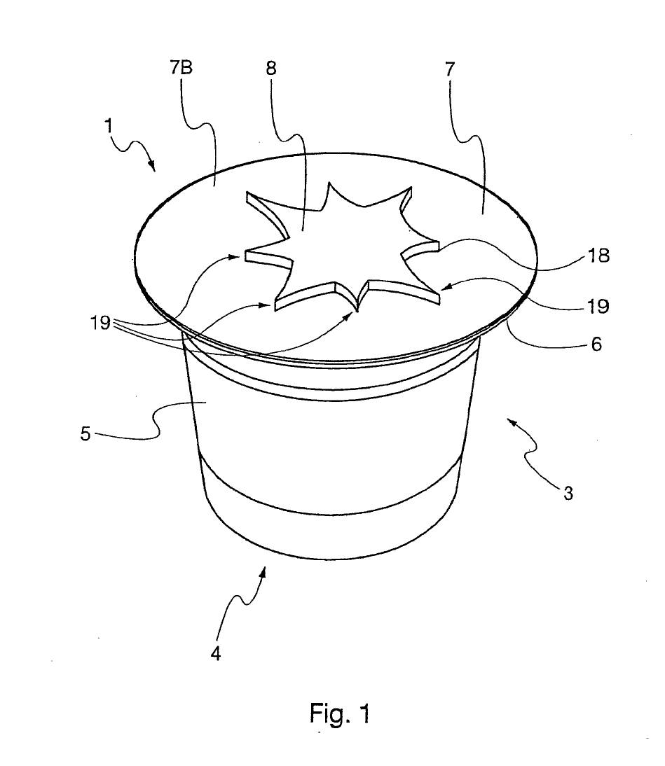

FIG. 1 is a perspective view of a capsule showing the lid;

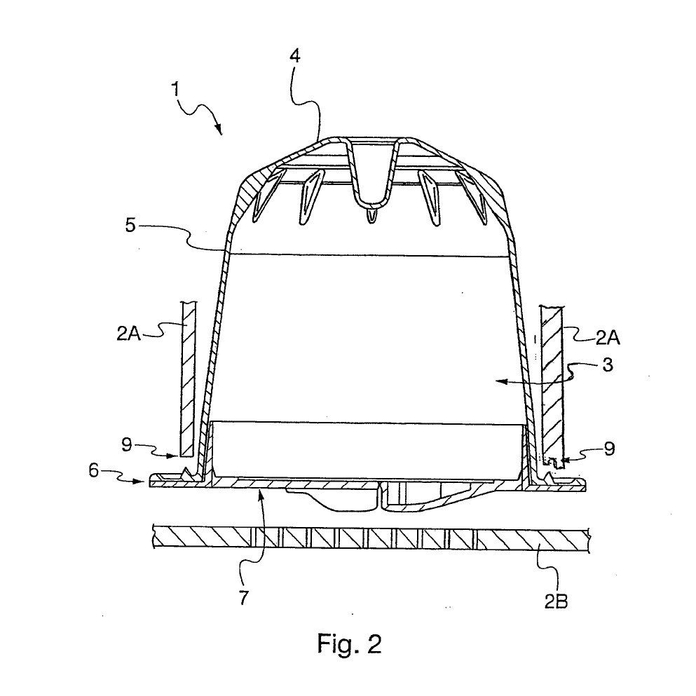

FIG. 2 is a sectional schematic view of a capsule in a brewing device;

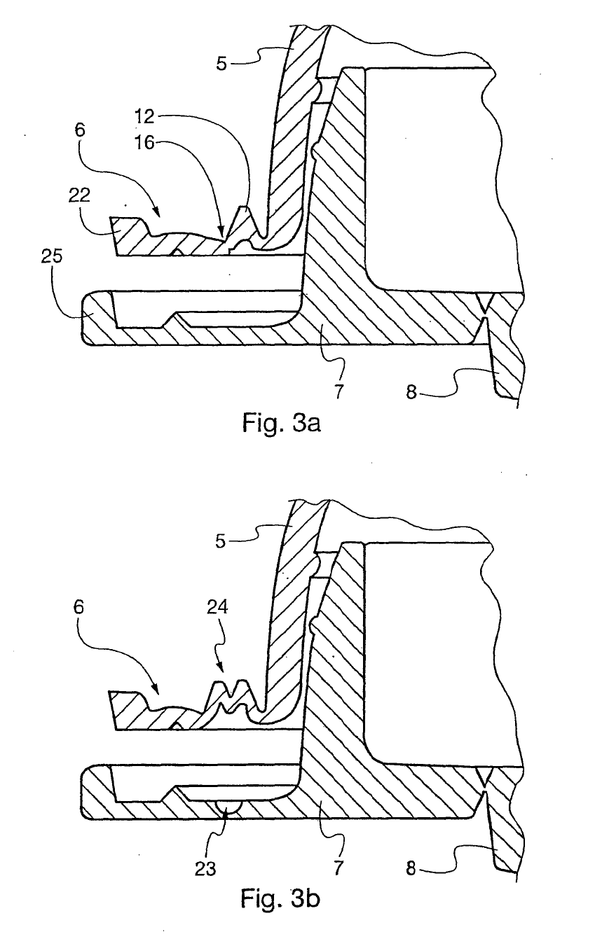

FIGS. 3a and 3b are an enlarged sectional view of a sealing area according to two alternative embodiments of the invention;

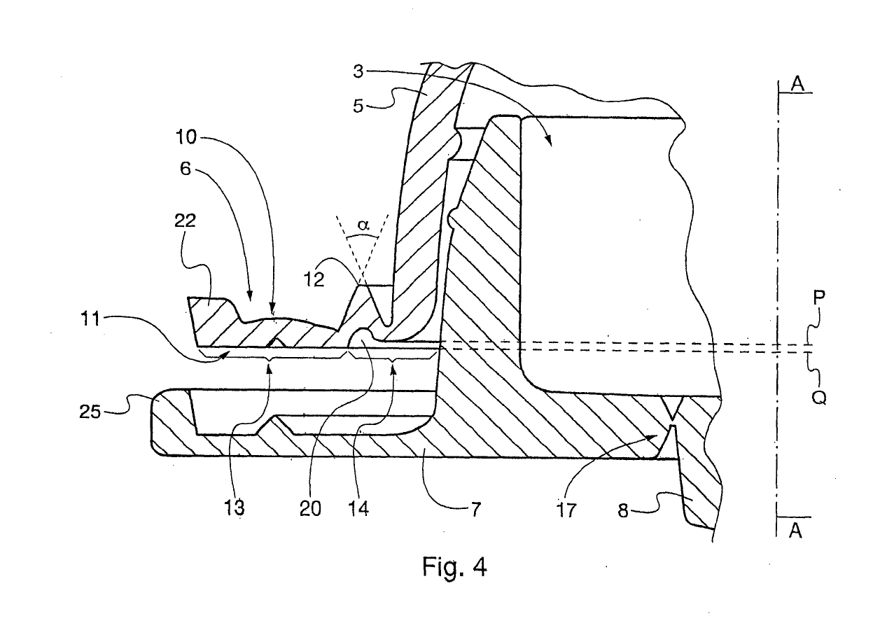

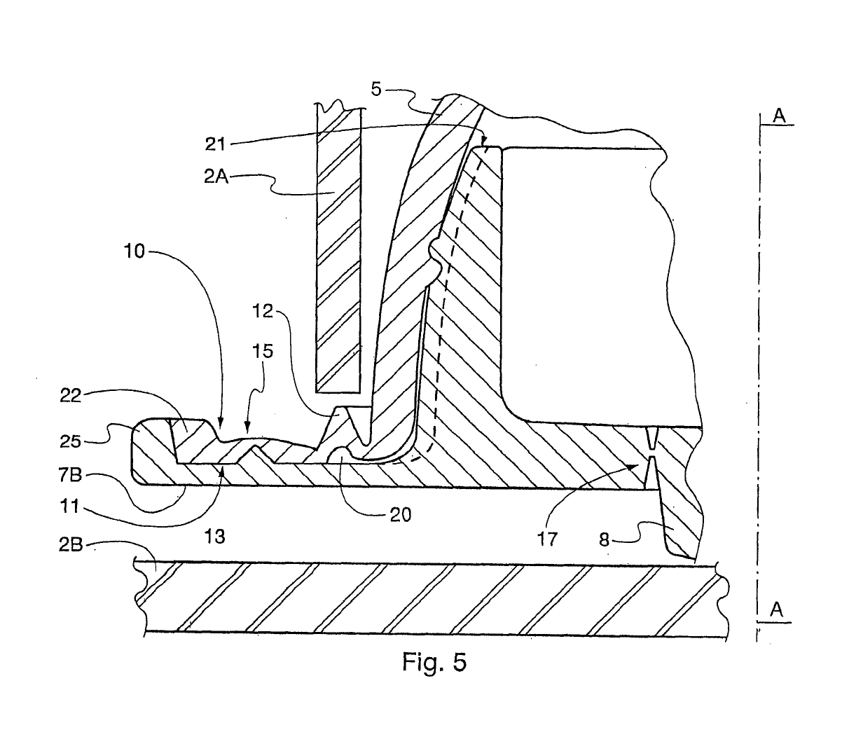

FIGS. 4 and 5 show an enlarged view of an exemplary embodiment of the invention;

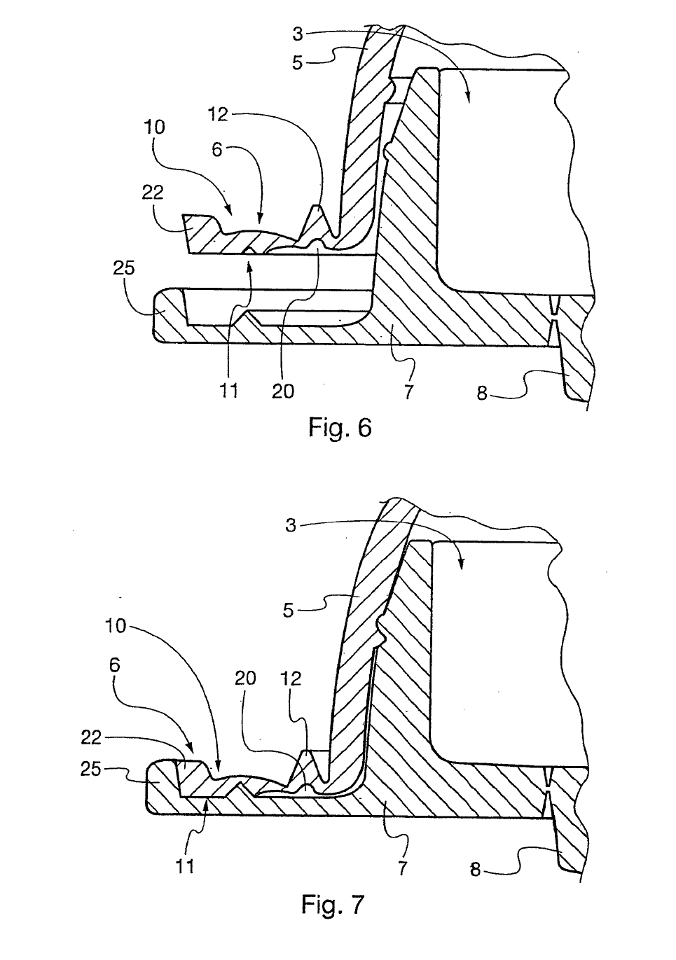

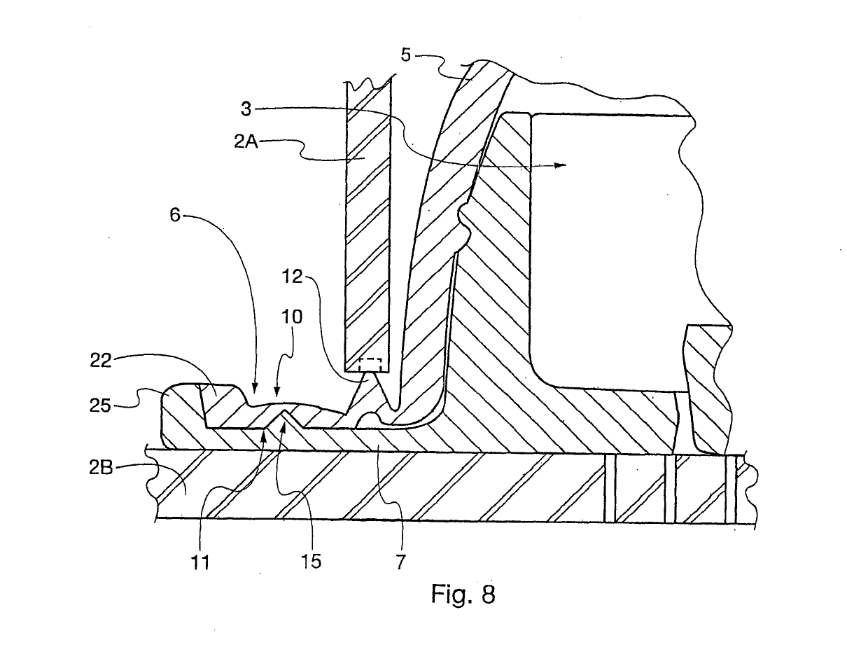

FIGS. 6 and 7 show another exemplary embodiment of the invention;

FIG. 8 schematically shows a compressed condition of flange and sealing element,

FIG. 9 shows a compressed condition of another exemplary embodiment of the invention;

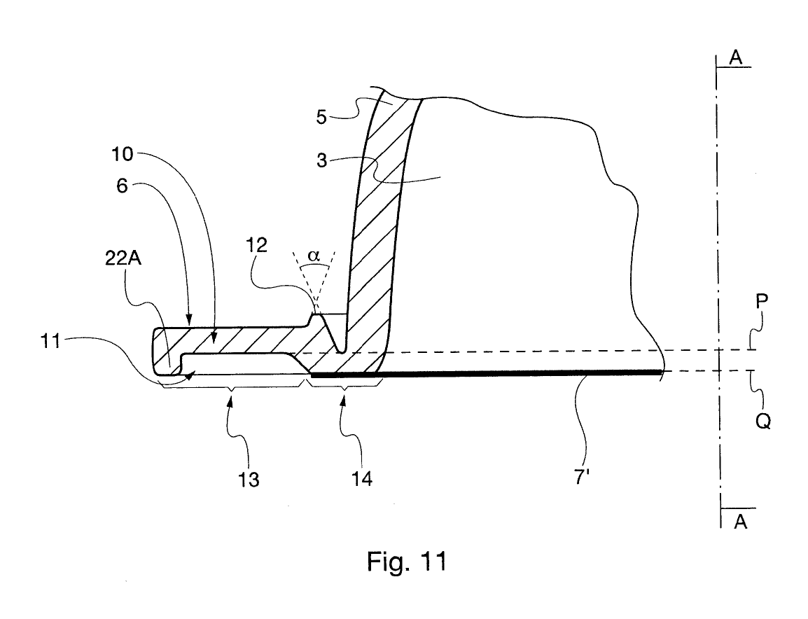

FIGS. 10 and 11 are sections of details of other embodiments of the invention.

As visible in FIG. 1, a capsule 1 for beverage preparation is comprising a hollow body 3 including an inlet wall 4, a lateral wall 5 and a flange rim 6. In FIG. 1 is shown an outlet wall 7 that is a lid, for instance in molded thermo-plastics or thermo-formed laminate, having a self-piercing portion 8; other types of outlet walls are also possible, such as e.g. a foil 7′ that can be perforated or that can be ruptured or torn, or a pre-perforated foil, and other types of walls available to the skilled in the art. The capsule is to be used with a brewing device that can feed water to the capsule through the inlet wall 4 and retrieve the beverage from outlet wall 7. The flange rim 6 has (FIG. 4-9) an upper side 10 and a lower side 11 and a sealing element 12 located on the upper side 10 of said flange rim. The meaning of “upper” and “lower” was discussed above and refers to axis A-A and the position as shown in the figures. As visible in FIG. 2, the capsule can be used in a brewing device that includes a first part 2A forming a receptacle for housing at least part of the capsule 1 and a second part 2B that cooperates with the first part in the brewing of the beverage from the capsule; the first and/or second part 2A, 2B are mobile with respect to each other, e.g. the part 2A is mobile and the part 2B is fixed, or viceversa. The receptacle, i.e. part 2A, has a lower edge, i.e. a pressing edge, 9 that enters into contact with the sealing element 12 (when from the position shown in FIG. 2 the receptacle 2A is moved with respect to the part 2B of the brewing device, or vice versa) to compress it against the second part 2B for providing a seal tight engagement with the capsule during the beverage preparation process.

In FIG. 2 are shown to possible shapes of pressing edge 9: on the left side the pressing edge is substantially flat and on the left side the pressing edge is provided with a groove that divides the pressing edge into two portions. Both these shapes are well known in the art.

The sealing element 12 can have different shapes, preferably it is formed by at least one, possibly also a plurality, protruding element(s) that is (are) circumferential to the capsule body; in the shown embodiment the sealing element 12 has a cross-section that is in the shape of a truncated triangle, the sides of said triangle extending from flange rim 6. Preferably, the sealing element is spaced from lateral wall 5 of the capsule to provide a seat for element 2A.

More generally, the sealing element 12 comprises a portion having a substantially triangular cross-section with two sides lying on two straight lines that extend from the upper surface of the flange rim 6 and define an angle α (FIG. 4) within the range 35°-120, preferably of around 40-50°. In another embodiment, the sealing element is in the form of a local increased thickness of the flange, or has shapes different from a triangle.

According to the invention as shown in particular in FIGS. 4 and 5, the lower side 11 of the flange 6 comprises at least two portions 13, 14 that lie on two or more planes that are at different levels with respect to the capsule axis (A-A; see FIGS. 4 and 5); in the embodiment shown, there are two portions that lie on two planes, P and Q; in greater detail, portion 13, lying on plane Q, extends from the edge of the flange 6 to the sealing element 12, excluded, while the portion 14, lying on plane P, extends from the sealing element 12 (included) to the lateral wall 5 of the capsule body 3. Planes P and Q are at different heights with respect to axis A-A of the capsule, i.e. they meet the axis A-A at different points.

In an exemplary embodiment, the upper side of the flange is preferably in a single plane, i.e. portions of flange 6 on either side of the sealing element 12 are preferably coplanar. In another embodiment, see FIGS. 10 and 11, the lower side 11 of flange 6 has portions that are on planes at different levels and possibly also at different inclinations with respect to axis A-A.

As mentioned, the planes are at different levels with respect to axis A-A of the capsule and plane P is higher, i.e. it is closer to the inlet wall 4 of the capsule, and vice versa for plane Q, that is the lower plane (closer to outlet wall 7).

The result of having different planes is that the flange rim 6 of the capsule body is spaced from the layer formed by outlet wall 7 extending along flange rim 6, so as to provide a space, or cavity, 20 to receive a portion of the flange rim 6 when the sealing element 12 is compressed in the brewing device. FIG. 8 schematically shows a compressed condition of the flange 6 and the sealing element 12. Both are moved by edge 9 of receptacle 2A downwards, against the outer wall 7 and part 2B of the brewing device.

There can be several different configurations of the portions 13 and 14 and of the corresponding planes Q, P; in FIGS. 5 to 7 are shown two similar embodiments in which the sealing element 12 is spaced from the outer wall and where the space 20 in one case stops at the sealing element 12 outer edge and in the other case continues towards the edge of the flange 6. The flange and the outlet wall 7 are preferably welded together at a location 15 (see FIGS. 5 and 8) that is between the edge of the flange rim 6 and the sealing element 12. In FIGS. 5 and 7 the flange 6 in correspondence of the welding position 15 has a thickness greater than in the rest of the flange, excluding the edge of the flange. The upper part of the flange rim has an embossed part, to provide roughly a continuous thickness despite the indent created on the lower side of the rim, to convey the energy provided by an ultra-sound sonotrode, in case of ultra sound welding of the lid.

In the shown embodiments, the spacing is provided on the lower side of the flange rim 6, but the same effect can be obtained with a spacing located in the upper side of the outlet wall, or with a combination of the two, on the lower side of the flange and on the upper side of the outlet wall. Clearly, although not directly relevant to the invention, also the indent for conveying the ultrasound energy can alternatively be placed with the female part on the lower side of the rim, as well as on the upper side of the lid.

FIGS. 3a and 3b refer to other possible embodiments of the present invention. In FIG. 3a the sealing element 12 is provided with a groove 16 located on its outer side (the side looking away from the capsule body 3). The groove 16 is broken when the sealing element 12 is compressed by part 2A and the sealing element can rotate counterclockwise and be moved against the outlet wall 7. This embodiment, therefore, relates to a capsule wherein an area of the flange in correspondence to the sealing element 12 is spaced from the outlet wall 7 and a groove 16 is provided in that area to give a breakable line that will break if the pressure of the compression is high enough. If there no such high pressure, e.g. because the distance between part 2A and 2B is sufficient to avoid excessive compression, the sealing element 12 will be compressed in a “normal” way, i.e. groove 16 will not break, so that a sealing effect is obtained just by compression.

FIG. 3b shows another embodiment, in which the sealing element 24 is a double cuspid, roughly shaped as an “M”, and the upper side of the outlet wall 7 is provided with a groove 23 large enough to house, if necessary, the central part of the M-shaped sealing element when this part is compressed downwards.

FIG. 9 shows another possible embodiment of the invention, wherein a sealing member 12 is spaced from the lateral wall 5 of the capsule so that when receptacle 2A of the brewing device is moved with respect to the second part 2B, or vice versa, the receptacle 2A is positioned between the lateral wall 5 of the capsule and the sealing member 12. FIG. 9 shows the capsule when already compressed between parts 2A and 2B and the sealing element 12 has been deformed. In this embodiment space 20 is mainly located under the portion of flange between sealing member 12 and lateral wall 5; when the flange is compressed the sealing element is rotated towards the lateral wall 5 and can contact receptacle 2A to improve the sealing effect.

It has to be noted that the edge 9 of the receptacle 2A of the brewing device can be brought in contact at least partially with the inner lateral surface 12A of the sealing member. According to a possible embodiment, see e.g. FIG. 10, the receptacle 2A can be brought into contact both with the lateral wall 5 of the capsule and the sealing member 12, in particular with the inner lateral surface 12A of the sealing member 12. In the embodiment according to FIG. 9, in the compressed condition, the portion 14 of the flange rim 6 is moved downwards by the receptacle 2A against the outer wall 7 and the second part 2B of the brewing device. By doing so, the sealing member 12 rotates, at least partially, towards the external surface of the receptacle 2A, thus increasing the seal tight engagement between the receptacle 2A and the capsule.

The embodiment shown in FIG. 10 is similar to the one of FIG. 9 in that there is a space provided between sealing element 12 and lateral wall 5 of the capsule, where the edge 9 of the receptacle 2A can be housed during the brewing process. In the embodiment of FIG. 10 the cavity 20 on the lower side of flange 6 is located in the portion of lower side going from the sealing element 12 to the end of the flange 6. Portion 14 of the lower side, between lateral wall 5 and sealing element 12 is substantially flat. The outlet wall 7′ is made of a foil known in the art and the portion 2B of the brewing device is provided in a way known in the art with piercing elements 7A that will break the foil 7′ during the brewing process.

As visible in FIG. 10, the lower side 11 has different portions that lie on different planes, namely planes Q, P and P; plane P′ is inclined with respect to planes P and Q and crosses them. The planes meet the axis A-A at different levels.

In another embodiment, upper side 10 of the flange rim 6 is provided with a flat surface shown by dotted line L; in this embodiment, as in the embodiment of FIG. 9, the sealing is obtained by the action of pressing receptacle 2A on the side of sealing element 12, preferably also on the side of lateral wall 5. Thus, it is not necessary that the sealing element is in the form of a triangle or ridge protruding from the flange rim 6: as mentioned, the upper side of flange 6 can be flat (as per line L) and the sealing element can be in the form of an increase in the thickness of the flange.

In this embodiment, the presence of the cavity or space 20 will allow a deformation of the sealing element 12 towards the end of the flange, if necessary, when compressed by the receptacle 2A, especially when the compression is lateral. In other words, when the receptacle compresses the sealing element the space 20 is suitable to “receive” the part of flange 6 that is pushed against part 2B of the brewing device; in particular when the compression path of receptacle 2A is greater than the standard compression path for which the sealing element is designed, space 20 can accommodate, i.e. receive, a deformed portion of the capsule flange so as to compensate the excess of compression on the sealing element 12.

A similar effect occurs also in the embodiment of FIG. 11, where the space 20 on the lower side of the flange is provided in portion 13 of the flange. FIGS. 10 and 11 also show an embodiment of the flange, that is not limited to the embodiments of said FIGS. 10 and 11, wherein the edge of the flange is provided with a ridge 22A that extends downwards with respect to the flange.

The embodiments shown are provided with a wall 7 that is formed by a lid (see e.g. FIG. 1) that is provided with an opening comprising self-piercing elements 8. In the shown embodiment, the capsule is provided with one central outlet means 8, but this single means can be replaced with a plurality of self-perforating elements 8 on the lower wall 7. The lid having said self piercing elements (independently on their number and shape) is preferably provided internally with ribs, if made from injected thermoplastic, or corrugated thermo-formed plastic, to make the lid more rigid and help the self-perforation of the lid. The self-perforating elements 8 comprise a portion protruding at least in part from the lower surface 7b of outlet wall 7, that are breakable under the action of the mechanical force exerted by the brewing device and/or the force exerted by the water fed into the capsule. In particular, as shown in the enlarged view of FIGS. 4 and 5, elements 8 are defined by a portion of reduced thickness 17 of lower wall that can be broken when the part of element 8 that protrudes from outlet wall 7, is pressed against part 2B of the brewing device. Different designs for the reduced thickness area can be used, to achieve varying degree of ease of breaking, depending on the desired quality and type of beverage. For instance the reduced thickness can be extended horizontally into a plane on either or both sides of the breakable area. Preferably a hinge ensures that ribs can oscillate and open without completely breaking away from wall 7, although embodiments using wholly breakable portions are also envisageable.

This type of self-perforating elements is described in detail in the patent application WO2007/063411, in the name of the Applicant.

Another type of outlet means has a corresponding plurality of protruding elements 8, but the groove at the periphery of the rib is replaced by a very thin cut, where wall 7 is not present, i.e. with a pre-cut area, a hinge portion being still present; additionally, in this exemplary embodiment the ribs can protrude both outwardly and inwardly with respect to wall 7.

It has to be noted that the above mentioned outlet elements can be opened, or its pre-cut openings widened to provide the desired free passage, under the action of the mechanical force, or by means of the brewing liquid pressure, or as a result of the combined action of the brewing liquid pressure with the mechanical force exerted by the brewing device.

One preferred embodiment of lid (shown in FIG. 1) has one or more self-perforating elements 8 that are defined by grooves 18, said grooves 18 form a pattern that includes a plurality of acute angles 19 to concentrate the mechanical stresses on said points.

Instead of a lid, the outlet wall 7 can be in the form of a foil or membrane 7′, in particular a foil that is a laminate providing a barrier at least to oxygen. The opening of the foil is obtained in a known way against part 2B that e.g. will have a plurality of protruding members 7A for lacerating the foil. Preferably, the foil is secured, e.g. welded, to at least portion 13 of the lower side of flange 6, but it can be secured to the whole of the lower side of the flange. In this case, the portion of part 2B of the brewing device that will contact with the foil in correspondence to the capsule's flange rim 6, is preferably plane to help in obtaining the required sealing effect, or it will have raised portions to ensure proper opening of the foil.

In an exemplary embodiment of the invention, shown in FIG. 5, the space 20 between flange 6 and wall 7 is connected to the inside of the capsule 3, e.g. by a channel 21, shown in dotted lines in FIG. 5. In this embodiment, the water, or water and air or other fluid fed in the capsule body will reach the space 20; the pressure in space 20 will thus be the same as the pressure in the capsule 3, the internal pressure will counteract to the compression pressure and the sealing effect will be improved.

Finally, in order to increase the rigidity of flange rim 6, the peripheral portion of outlet wall 7, when this is a lid, has an edge 25 that that extends vertically along the edge 22 of the capsule flange rim, so as to partially house and support it and to double the thickness of flange edge 22.

Finally, it is reiterated that the present improved sealing element 12 can be used with any type of capsule that requires a sealing effect between capsule and one or more elements of the brewing device. The capsule shown in FIG. 1 and FIG. 2 is a sealed capsule, but the sealing element of the invention is providing a technical effect also with open capsules, i.e. with capsules where inlet wall 4 and/or outlet wall (lid or membrane) is provided with openings for water and beverage passage. Similarly, the sealing element of the invention can be positioned on other parts of the capsule, where its sealing action is required.

1-19. (canceled)

20. A capsule for preparing a beverage in a brewing device, comprising:
a hollow body including an inlet wall, a lateral wall, and a flange rim, the flange rim including an upper side and a lower side and a sealing element located on the upper side of the flange rim,
wherein the lower side of the flange rim comprises at least two portions that lie on two or more planes that are at different levels with respect to the capsule axis.

21. A capsule according to claim 20, wherein the different levels provide at least one space, or cavity, on the lower side of the flange rim to receive a portion of the flange rim when the sealing element on the flange rim is compressed.

22. A capsule according to claim 20, wherein the space is located, on the lower side, at a position that is opposite to the sealing element and/or adjacent to the sealing element.

23. A capsule according to claim 20, wherein at least one of the planes crosses at least one of the other planes.

24. A capsule according to claim 20, further comprising an outlet wall closing the capsule body, the outlet wall extending along at least part of the flange rim to provide a lid including at least one layer of material under the flange rim, wherein the flange rim of the capsule body is vertically spaced from the layer formed by the lid at least in an area where the sealing element is located, to provide a space to receive a portion of the flange rim when the sealing element is compressed in the brewing device.

25. A capsule according to claim 20, wherein the sealing element is spaced from the lateral wall of the capsule.

26. A capsule according to claim 20, wherein the lower side of the flange rim includes a first portion extending from the sealing element towards an outer edge of the flange and a second portion that includes at least part of the sealing element and that extends to the lateral wall of the capsule body, the plane of the second portion being closer to the inlet wall of the capsule than the plane of the first portion of the flange to provide the space.

27. A capsule according to claim 26, wherein the space is connected to an inside of the capsule.

28. A capsule according to claim 20, wherein the lower side of the flange rim includes a first portion extending from the sealing element towards an outer edge of the flange and a second portion that includes at least part of the sealing element and that extends to the wall of the capsule body, wherein at least one space is located at the first portion, or including part of the flange opposite to the sealing element.

29. A capsule according to claim 20, wherein the sealing element has a cross-section that is in a shape of a truncated triangle, sides of the triangle extending from the flange rim.

30. A capsule according to claim 20, wherein the sealing element comprises a portion having a substantially triangular cross-section with two sides lying on two straight lines that extend from the upper surface of the flange rim and define a top angle of the triangle that is within the range 35°-120°.

31. A capsule according to claim 17, wherein the flange has a peripheral portion that is directed downwards.

32. A lid for a capsule for preparing beverages, the capsule including a hollow body including an inlet wall, a lateral wall, and a flange rim, the lid comprising:
a central portion that closes the hollow body of the capsule and a peripheral portion that cooperates with the flange rim of the capsule body;
outlet means in a form of a plurality of self-perforating elements that are projecting outwardly from the lid and that are defined by grooves; and
wherein grooves form a pattern that includes a plurality of acute angles.

33. A lid according to claim 32, wherein the self-perforating elements are breakable under action of a mechanical force exerted by the brewing device and/or force exerted by water fed into the capsule.

34. A lid according to claim 32, wherein the peripheral portion has an edge that extends vertically along an edge of the capsule flange rim.

35. A beverage preparation system, comprising:
a capsule according to claim 20, the capsule including a flange rim and a space or cavity located on a lower side of the flange rim; and
a brewing device including a first part with a receptacle for housing at least part of the capsule and a second part that cooperates with the first part in the brewing of the beverage from the capsule, the first and/or second part being mobile;
wherein the receptacle comprises a lower edge that enters into contact with the sealing element to compress the sealing element against the second part for providing a seal tight engagement with the capsule during a beverage preparation process, wherein the space is configured to receive at least part of the flange rim that is compressed against the second part of the brewing device by the first part.

36. A beverage preparation system according to claim 35, wherein the capsule comprises a lid and the second part further comprises means for exerting a mechanical force against self-perforating portions of the lid of the capsule.

37. A process of preparing a beverage from a capsule according to claim 36, the capsule comprising a hollow body including an inlet wall, a lateral wall, and a flange rim, the flange rim including an upper side and a lower side and a sealing element located on the upper side of the flange rim, the capsule having a flange rim and a space or cavity located on the lower side of the flange rim,
the brewing device comprising a first part and a second part mobile with respect to each other,
the sealing element is compressed by the first part and is moved towards the second part together with a portion of the flange rim of the capsule,
wherein the space receives at least part of the flange rim that is compressed against the second part of the brewing device by the first part.

38. A process according to claim 37, wherein a brewing fluid is fed to the inside of the capsule and the brewing fluid reaches an area below the sealing element and/or the flange rim of the capsule to at least in part counteract mechanical pressure of the first part.
